(19) United States
(12) Patent Application Publication
(10) Pub. No.: US 2005/0065870 A1
(43) Pub. Date: Mar. 24, 2005

(54) Web transaction system and method thereof

(76) Inventor: Ming-Yu Yu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/940,021

(22) Filed: Sep. 14, 2004

(30) Foreign Application Priority Data
Sep. 24, 2003 (TW) 92126414

(51) Int. Cl. G06F 17/60

(52) U.S. Cl. 705/37

(57) ABSTRACT

A web transaction system and a method thereof provide an intermediary platform for network transaction. Thereby, the present invention can make a first consumer able to provide a first article information and a self-determined price on-line and automatically perform a intermediary process directed to a second article information provided by a second consumer to exchange the first article corresponding to the first article information and the second article corresponding to the second article information. In addition, the present invention also provides a valuation platform to find out the prices of articles similar to the first article and the second article from preset famous shopping or auction websites and calculate a first reference price and a second reference price. Network consumers can determine the prices of their articles according to the reference prices.

### BACKGROUND OF THE INVENTION

1. Field of the Invention

The present invention is related to a web transaction system and a method thereof that provide an intermediary platform for network transaction. The present invention is more particularly related to a system and a method that make a first consumer able to provide a first article information and a self-determined price on-line and automatically perform a intermediary process directed to a second article information provided by a second consumer.

2. Description of Related Art

Since human being had transaction behaviors, articles were exchanged with articles on the market. However, due to the huge difference between the articles, unfair events happened all the time because the values of the articles were hard to determine. For example, it is hard to determine how many bowls are required to exchange with a cattle or how many sick cattle are required to exchange with a golden bowl. Fortunately, human being progressed to currency times gradually. After that, all articles are valued based on currencies in advance and then the currencies are used for transaction.

The transaction method using currencies mentioned above is completely suitable to be used in the present transaction behaviors of human being. Even though human being has entered the information time and Internet is brought into vogue, all electronic commerce still uses currencies for article transaction.

Furthermore, due to the vigorous development of the network and information technologies, the electronic commerce is springing up. That makes the traditional commercial activity be changed in various ways. Therein, the C2C (Customer to Customer) management is a typical case. The so-called C2C management is to gather a great number of buyers and sellers together for on-line transaction. For example, eBay auction website and YAHOO auction website are the largest auction websites in the world.

Reference is made to FIG. 1, which is a flow chart of a conventional method for on-line transaction. Therein, after a network buyer 10′ enters an auction website 20′ via Internet and applies for the membership of the auction website 20′, he can use the shopping homepage 30′ provided by the auction website 20′ to search the articles with several searching commands. At this time, the auction website 20′ searches the articles according to the searching commands and finds out the related articles 40′. Subsequently, the auction website 20′ shows the pictures, specifications and the highest bids of the related articles. Thereby, the network buyer 10′ can read the list of the related articles 50′ and then bid for the articles 60′ according to his need and budget. After the biding time is ended, the auction website 20′ issues a message to inform the network buyer 10′ and the network seller 80′ that the transaction is succeeded in accordance with the principle that high price wins the bid 70′. Then, the network buyer 10′ can pay for the article.

As described above, the auction websites usually force the consumer to be a buyer and a seller concurrently. For example, the seller first needs to sell his articles and get the payment; then, he has to switch his place to a buyer so as to buy the article he really needs. That forces the consumer to repeat the transaction actions and lengthen the transaction time. Thus, it not only makes the on-line transaction actions become complex and lengthy but also reduces consumer's willingness for on-line transaction.

However, the currencies are only used for article evaluation. In other words, human being sells the articles to obtain the currencies and then uses the currencies to obtain the articles he really needs. It means that human being still lasts the original transaction behavior, i.e. exchanging articles with articles.

As the discussion above, the present invention proposes a system and a method to develop a novel on-line transaction behavior according to the network technology. Therefore, how to propose a web transaction system and its method to resolve the drawbacks of the prior art so as to last the original transaction behavior, i.e. exchange articles with articles, and provide the fair prices of the articles for the consumer via a valuation platform has been desired for a long time.

Accordingly, in view of the research, development and practical sale experiences for many years, the inventors of the present invention sought to improve the prior art. Via inventors' professional knowledge and his research, design and case study in many ways, the inventors finally propose a web transaction system and its method able to resolve the drawbacks mentioned above.

### SUMMARY OF THE INVENTION

An objective of the present invention is to provide a web transaction system and a method thereof. The present invention provides an intermediary platform for network transaction to make a first consumer able to provide a first article information and a self-determined price on-line. The system of the present invention can automatically perform a intermediary process directed to a second article information provided by a second consumer for network transaction.

Another objective of the present invention is to provide a web transaction system and a method thereof that provide a valuation platform. Therein, the valuation platform can find out the prices of similar articles from preset famous shopping or auction websites and calculate reference prices according to a specific weighted average method and a depreciation rate. The network consumers can determine the prices of their articles according to the reference prices.

Still another objective of the present invention is to provide a web transaction system and a method thereof that can fast satisfy the requirements of network consumers. Therein, network consumers can directly provide an article for sale and then sell it via the system of the present invention. During transaction, the system of the present invention uses the valuation platform to evaluate the price of the article so as to simplify the complex price comparison process in the prior art and greatly reduce the transaction time.

Still another objective of the present invention is to provide a fair article valuation method. It uses a valuation platform to find out the prices of similar articles from preset famous shopping or auction websites to fairly provide a reference price of the article for sale.

For achieving the objectives above, the present invention provides a web transaction system and a method thereof that provide an intermediary platform for network transaction. Thereby, the present invention can make a first consumer able to provide a first article information and a self-determined price on-line and automatically perform a intermediary process directed to a second article information provided by a second consumer.

The present invention also provides a valuation platform to find out the prices of similar articles from preset famous shopping or auction websites and calculate reference prices of the articles for sale. Network consumers can determine the prices of their articles according to the reference prices.

Furthermore, the present invention can fast satisfy the requirements of network consumers, simplify the complex price comparison process in the prior art and greatly reduce the transaction time. Hence, the web transaction system and method of the present invention can be applied for Internet nowadays.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a flow chart of a conventional method for on-line transaction.

FIG. 2 is a schematic diagram of a preferred embodiment of a web transaction system in accordance with the present invention.

FIG. 3 is a flow chart of a preferred embodiment for on-line transaction in accordance with the present invention.

FIG. 4 is a flow chart of a preferred embodiment for article valuation in accordance with the present invention.

FIG. 5A is a block diagram of a preferred embodiment for the web transaction system and method complied with the present invention.

FIG. 5B is a block diagram of another preferred embodiment for the web transaction system and method complied with the present invention.

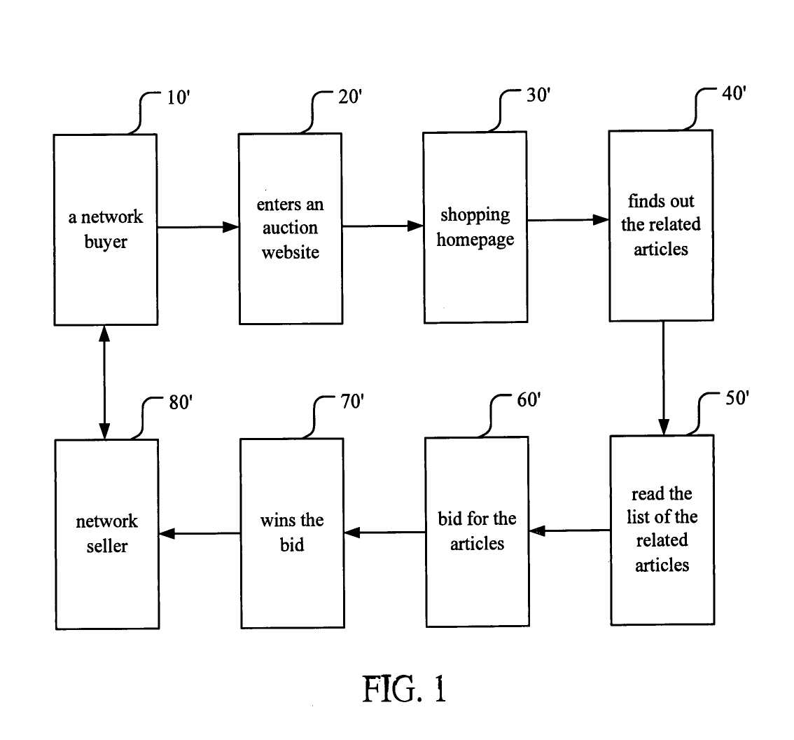

### DETAILED DESCRIPTION OF PREFERRED EMBODIMENTS

The main feature of the present invention is to use a server as an intermediary platform, which is connected to Internet, to receive the article information provided by the first consumer, such as article name, purchase time, self-determined price, article picture or the like. After the consumer provides the article information, the intermediary platform of the present invention requests the valuation platform to find out the prices of similar articles from predetermined famous shopping or auction websites of the Internet for comparison. In the embodiments of the present invention, the valuation platform usually uses about one hundred of similar articles to valuate the price of the article for sale. In general, the valuation platform provides a price range for the consumer to determine the price of his article. In addition, the valuation platform usually considers the purchase time and valuates the article with a depreciation rate. The valuation platform usually discounts the article for depreciation. After finishing the valuation process, the system of the present invention declares all the prices ranges of the articles on-line for consumers' reference during transaction.

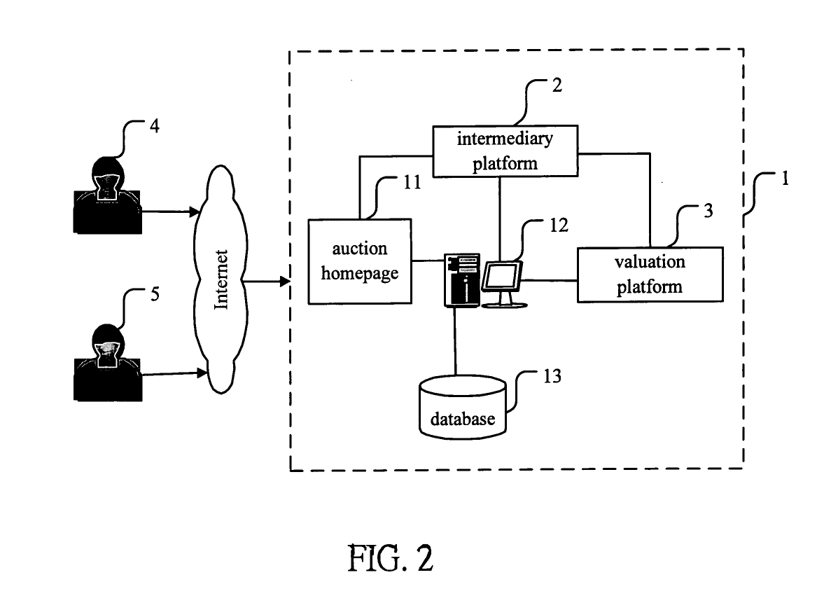

Reference is made to FIG. 2, which is a schematic diagram of a preferred embodiment of a web transaction system in accordance with the present invention. The system mainly includes a website system 1, which is used to provide a transaction platform for on-line transaction. Suppose that the first consumer 4 tries to carry out on-line transaction via the functions of Internet. Initially, the first consumer 4 inputs the address of the website to connect with the website system 1 and enters an auction homepage 11. By using the server 12, the first consumer 4 can provide at least a first article information and a first price on-line. After connecting to the intermediary platform 2, the system automatically performs a transaction process to exchange the first article corresponding to the first article information and a second article corresponding to a second article information provided by a second consumer. During the operation mentioned above, the intermediary platform 2 requests the valuation platform of the present invention to find out the prices of similar articles from predetermined famous shopping or auction websites of the Internet for comparison. Then, the valuation platform valuates the articles for sale according to a weighted average method for the consumers to determine the prices of their articles.

The server 12 mentioned above keeps receiving the first article information and the first price prepared by the first consumer 4. At the same time, the server 12 also keeps receiving the second article information and the second price prepared by the second consumer 5. According to the first article information prepared by the first consumer 4 and the second article information prepared by the second consumer 5, the system will automatically connect with the famous shopping websites or auction websites in Internet to find out the prices of the articles similar to the first article and the second article. Then, the system will use the prices of multiple articles similar to the first articles and the prices of multiple articles similar to the second articles to calculate a first reference price and a second reference price according to a specific weighted average method.

The sever 12 is used to provide an intermediary process, a transaction process and valuation process for the first consumer 4 and the second consumer 5 who connect with the website system 1.

The database 13 is used to store the data related to the first consumer 4 and the second consumer 5, the first article information and the second article information, the first price and second price, and the first reference price and the second reference price.

The system has an intermediary platform 2 and valuation platform 3. When the first consumer 4 activates the auction homepage 11 and finishes preparing the information and price of the article on-line, the intermediary platform 2 will compare the price provide by the first consumer 4 to the prices of articles stored in the database 13. Meantime, the intermediary platform 2 will list all the corresponding articles possible for transaction. Then, intermediary platform 2 will automatically perform the intermediary process and the transaction process for the article provided by the second consumer 5 directly.

As for the valuation platform 3, when the first consumer 4 and second consumer 5 activate the auction homepage 11 and finish preparing the first article information and the second article information on-line, the valuation platform 3 will immediately connect with predetermined famous shopping websites and auction websites via the server 12 so as to find out the similar articles and calculate the first reference price and the second reference price. For example, when valuating the price of a P4 computer, the valuation platform 3 can connect to the website of the Kuang-Hua market (a famous computer-related market in Taipei) or connect to other famous websites related to computer transaction, find out prices of a hundred of P4 computers, calculate the reference price according to a predetermined weighted average method and a fair depreciation rate, and then provide the reference price for the consumer to determine the price of his article.

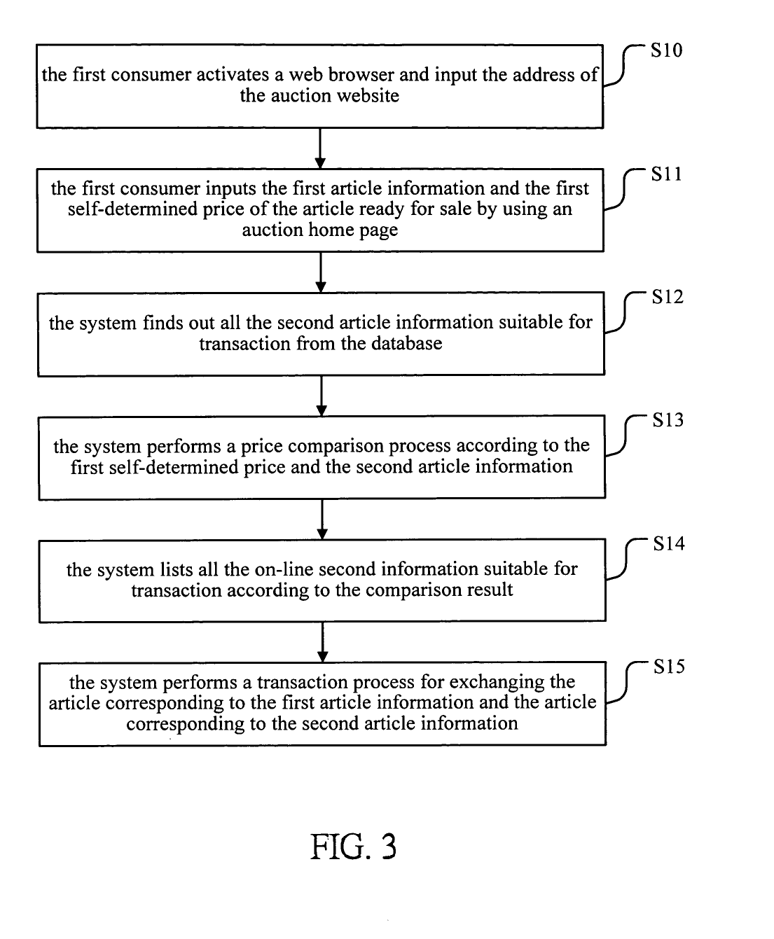

Therein, the method used for the intermediary platform 2 is described as follows. The reference is made to FIG. 3, which is a flow chart of a preferred embodiment for on-line transaction in accordance with the present invention. As shown in the figure, the web transaction system and method complied with the present invention have following steps:

Step S10: The first consumer activates a web browser and input the address of the auction website.

Step S11: Then, the first consumer inputs the first article information and the first self-determined price of the article ready for sale by using an auction home page.

Step S12: Subsequently, the system finds out all the second article information suitable for transaction from the database.

Step S13: The system performs a price comparison process according to the first self-determined price and the second article information.

Step S14: The system lists all the on-line second information suitable for transaction according to the comparison result.

Step S15: The system performs a transaction process for exchanging the article corresponding to the first article information and the article corresponding to the second article information.

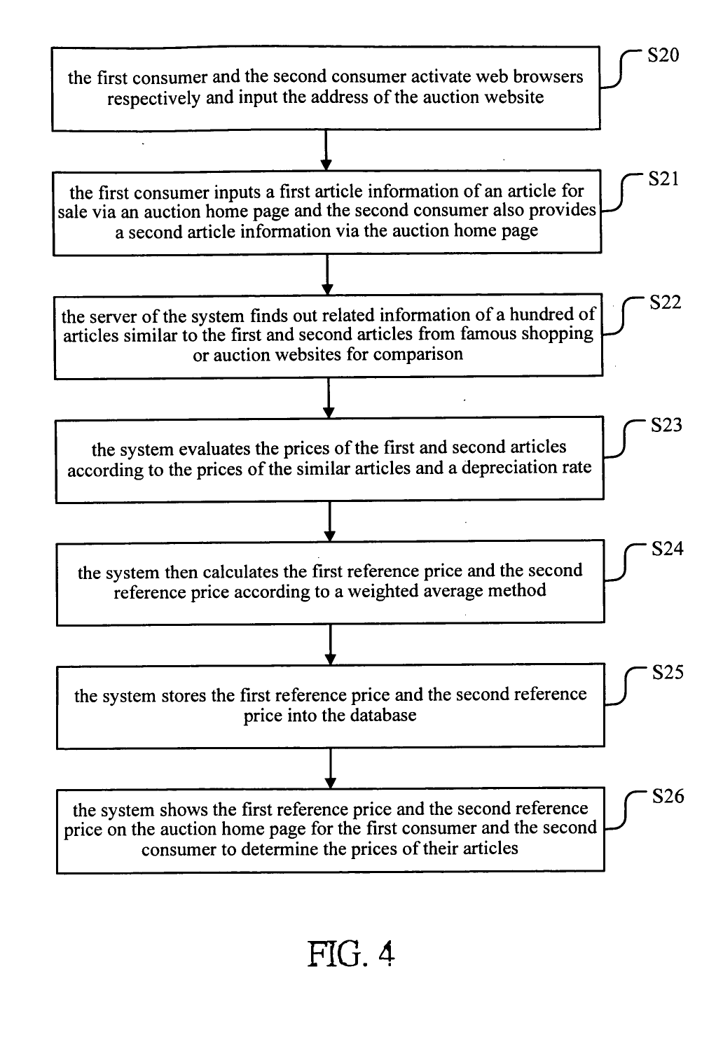

Therein, the system has a valuation platform 3 for fairly valuating the price of the article for sale so as to provide reference prices for the first consumer 4 and the second consumer 5 to determine the prices of their articles. The reference is made to FIG. 4, which is a flow chart of a preferred embodiment for article valuation in accordance with the present invention. As shown in the figure, the web transaction system and method complied with the present invention have following steps:

Step S20: The first consumer and the second consumer activate web browsers respectively and input the address of the auction website.

Step S21: Then, the first consumer inputs a first article information of an article for sale via an auction home page and the second consumer also provides a second article information via the auction home page.

Step S22: The server of the system finds out related information of a hundred of articles similar to the first and second articles from famous shopping or auction websites for comparison.

Step S23: The system evaluates the prices of the first and second articles according to the prices of the similar articles and a depreciation rate.

Step S24: The system then calculates the first reference price and the second reference price according to a weighted average method.

Step S25: The system stores the first reference price and the second reference price into the database.

Step S26: Finally, the system shows the first reference price and the second reference price on the auction home page for the first consumer and the second consumer to determine the prices of their articles.

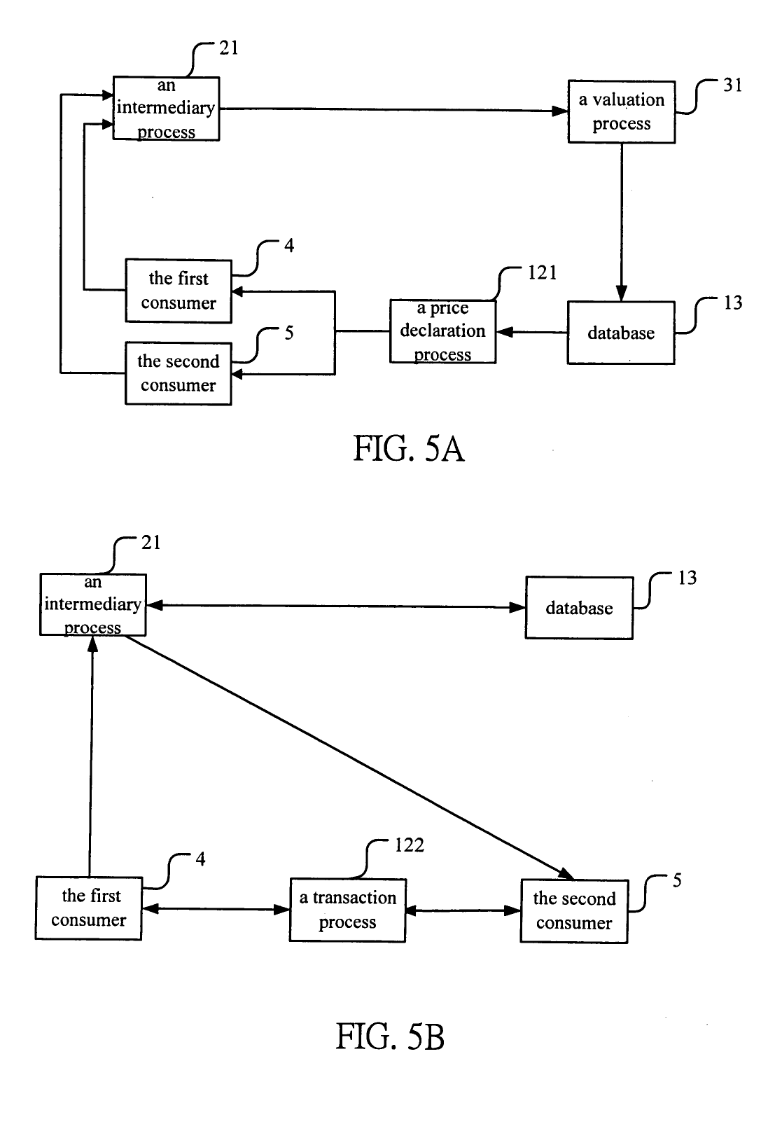

Therein, please refer to FIG. 5A, which is a block diagram of a preferred embodiment for the web transaction system and method complied with the present invention. As shown in the figure, the first consumer 4 and the second consumer 5 provide the first article information and the second article information on the intermediary platform 2 for transaction. The intermediary platform 2 uses an intermediary process 21 to receive the first article information and the second article information. Then, the intermediary platform 2 requests the valuation platform 3 to perform a valuation process 31. Via the valuation process 31, the valuation platform 3 can provide the first and second reference prices and store them into the database 13. The server 12 uses a price declaration process 121 to access the first and second reference prices from the database 13. After that, the server 12 declares the first and second reference prices and sends them to the first consumer 4 and the second consumer 5 to determine the prices of their articles.

Furthermore, the reference is made to FIG. 5B, which is a block diagram of another preferred embodiment for the web transaction system and method complied with the present invention. As shown in the figure, the first consumer 4 sends the first article information and the self-determined price to the intermediary platform 2. Via the intermediary process, the intermediary platform 2 send an article comparison request to the database 13. After finishing comparing the first article information with the second article information, the database 13 sends the corresponding article information suitable for transaction back to the intermediary platform 21 to proceed with the intermediary process. After completing the intermediary process, the system sends a transaction message to the second consumer 5. Thereby, the second consumer 5 can do business with the first consumer 4 via a transaction process 122.

By using the system and method of the present invention, the intermediary platform can be used for the first consumer to prepare the first article information of the article for sale. The intermediary platform can also list all the on-line second information suitable for transaction. The system can be used to directly exchange the article of the first article information and the article of the second article information according the second article information provided by the second consumer. The system can fast satisfy the requirements of the consumers, simplify the complex price comparison process and greatly reduce the transaction time. The valuation platform of the system can be used to find out the price of similar articles from famous shopping or auction websites according to the first and second article information. The valuation platform can also fairly calculate the reference prices according to a depreciation rate for the consumer to determine the prices of his article.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A web transaction system, comprising:
an intermediary platform for receiving a first article information of a first article for sale, the first article information being provided by a first consumer;
a valuation platform for providing a first reference price corresponding to the first article information; and
a database for recording the first article information and the first reference price;
wherein the intermediary platform is used for the first consumer to set a first self-determined price according to the first reference price; the intermediary platform is also used for a second consumer to provide a second article information and set a second self-determined price; thereby, the web transaction system is used for exchanging the first article corresponding to the first article information and a second article corresponding to the second article information.

2. The web transaction system as claimed in claim 1, wherein the database is used to record the second article information and the second self-determined price.

3. A web transaction method, comprising:
receiving a first article information of a first article, wherein the first article information is provided by a first consumer;
providing a first reference price directed to the first article information; and
recording the first article information and the first reference price in a database;
wherein the web transaction method is used for the first consumer to set a first self-determined price according to the first reference price; the web transaction method is also used for a second consumer to provide a second article information and set a second self-determined price; thereby, the web transaction method is used to exchange the first article corresponding to the first article information and a second article corresponding to the second article information.

4. The web transaction method as claimed in claim 3 further comprising a following step after the second self-determined price is set:
recoding the second article information and the second self-determined price in the database.

5. The web transaction method as claimed in claim 3, wherein the first reference price is obtained by using a weighted average process together with multiple prices of articles similar to the first article.

6. A web transaction system, comprising:
an intermediary platform for receiving a first article information of a first article for sale, the first article information being provided by a first consumer; and
a database for recording the first article information;
wherein the intermediary platform is used for the first consumer to set a first self-determined price; the intermediary platform is also used for a second consumer to provide a second article information and set a second self-determined price; thereby, the web transaction system is used for exchanging the first article corresponding to the first article information and a second article corresponding to the second article information.

7. The web transaction system as claimed in claim 6, wherein the database is used to record the second article information and the second self-determined price.

8. A web transaction method, comprising:
receiving a first article information of a first article, wherein the first article information is provided by a first consumer; and
recording the first article information;
wherein the web transaction method is used for the first consumer to set a first self-determined price; the web transaction method is also used for a second consumer to provide a second article information and set a second self-determined price; thereby, the web transaction method is used to exchange the first article corresponding to the first article information and a second article corresponding to the second article information.

9. The web transaction method as claimed in claim 8 further comprising a following step after the second self-determined price is set:
recoding the second article information and the second self-determined price in the database.

10. A web transaction system, comprising:
a server for receiving a first article information of a first article for sale and providing a first reference price corresponding to the first article information, wherein the first article information is provided by a first consumer; and
a database connected with the server for recording the first article information and the first reference price;
wherein the server is used for the first consumer to set a first self-determined price according to the first reference price; the server is also used for a second consumer to provide a second article information and set a second self-determined price; thereby, the web transaction system is used for exchanging the first article corresponding to the first article information and a second article corresponding to the second article information.

11. The web transaction system as claimed in claim 10, wherein the database is used to record the second article information and the second self-determined price.

12. A web transaction system, comprising:
an intermediary platform for receiving a first article information of a first article for sale, the first article information being provided by a first consumer;
a valuation platform for providing a first reference price corresponding to the first article information; and
a database for recording the first article information and the first reference price;
wherein the intermediary platform is used for the first consumer to set a first self-determined price according to the first reference price; the intermediary platform is also used for a second consumer to provide a second article information and set a second self-determined price according to a second reference price corresponding to the second article information provided by the valuation platform; thereby, the web transaction system is used for exchanging the first article corresponding to the first article information and a second article corresponding to the second article information.

13. The web transaction system as claimed in claim 12, wherein the database is used to record the second article information and the second self-determined price.

14. A web transaction method, comprising:
receiving a first article information of a first article, wherein the first article information is provided by a first consumer;
providing a first reference price directed to the first article information; and
recording the first article information and the first reference price;
wherein the web transaction method is used for the first consumer to set a first self-determined price according to the first reference price; the web transaction method is also used for a second consumer to provide a second article information and set a second self-determined price according to a second reference price corresponding to the second article information; thereby, the web transaction method is used to exchange the first article corresponding to the first article information and a second article corresponding to the second article information.

15. The web transaction method as claimed in claim 14 further comprising a following step after the second self-determined price is set:
recoding the second article information and the second self-determined price in a database.

16. The web transaction method as claimed in claim 14, wherein the first reference price is obtained by using a weighted average process together with multiple prices of articles similar to the first article.

17. The web transaction method as claimed in claim 14, wherein the second reference price is obtained by using a weighted average process together with multiple prices of articles similar to the second article.
